(19) United States
(12) Patent Application Publication
(10) Pub. No.: US 2011/0231582 A1
(43) Pub. Date: Sep. 22, 2011

(54) TREND DETERMINATION AND IDENTIFICATION

(76) Inventors: Mustafa Uysal, Vacaville, CA (US); Virginia Smith, Auburn, CA (US); Arif A. Merchant, Los Altos, CA (US)

(21) Appl. No.: 13/123,595

(22) PCT Filed: Oct. 13, 2008
(86) PCT No.: PCT/US08/79739

§ 371 Date: May 23, 2011

(51) Int. Cl. G06F 3/00

(52) U.S. Cl. 710/15

(57) ABSTRACT

A system comprises a processor and an alert module coupled to the processor. The processor the processor monitors performance data; determines a subset of the performance data, the subset correlated with a measure of underperformance; determines a trend of the subset, the trend correlated with the measure; and identifies an occurrence of the trend. The alert module outputs an alert based on the identification.

### BACKGROUND

In information processing environments, a vast variety of performance data is available. Performance data is collected by system performance monitors at the hardware level, operating system level, database level, middleware level, and application level. Collecting and using the large amount of performance data available is an onerous task requiring significant resources. In some cases, collecting and using performance data negatively impacts performance, and hence performance data, itself. Efficient collection and use of performance data is desirable.

### BRIEF DESCRIPTION OF THE DRAWINGS

For a detailed description of the embodiments of the invention, reference will now be made to the accompanying drawings in which:

FIG. 1A shows a system for trend determination and identification in accordance with at least some embodiments;

FIG. 1B shows a system for trend determination and identification in accordance with at least some embodiments;

FIG. 1C shows a stack providing performance data for trend determination and identification;

FIG. 2 shows a system having a computer readable medium for trend determination and identification in accordance with at least some embodiments; and

FIG. 3 shows a method of trend determination and identification in accordance with at least some embodiments.

### NOTATION AND NOMENCLATURE

Certain terms are used throughout the following claims and description to refer to particular components. As one having ordinary skill in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean an optical, wireless, indirect electrical, or direct electrical connection. Thus, if a first device couples to a second device, that connection may be through an indirect electrical connection via other devices and connections, through a direct optical connection, etc. Additionally, the term “system” refers to a collection of two or more hardware components, and may be used to refer to an electronic device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one having ordinary skill in the art will understand that the following description has broad application, and the discussion of any embodiment is meant only to be exemplary of that embodiment, and not intended to intimate that the scope of the disclosure, including the claims, is limited to that embodiment.

Trend determination and identification is disclosed. Self-tuning predictive performance models, based on machine learning, utilize performance data to monitor system performance levels, control the monitoring levels at various layers so that the variety and the detail of the performance data collected are decided dynamically, and determine potential service level objective violations. As such, the models capture performance data in different deployment scenarios, configurations, and workloads. The models tune and refine themselves to increase predictive performance. Furthermore, each piece of the multitude of performance data is available to be collected, but excessive and unnecessary monitoring is avoided, saving time and resources. Consequently, implementation of the models results in fewer violations as well as a time and resource advantage over competitors.

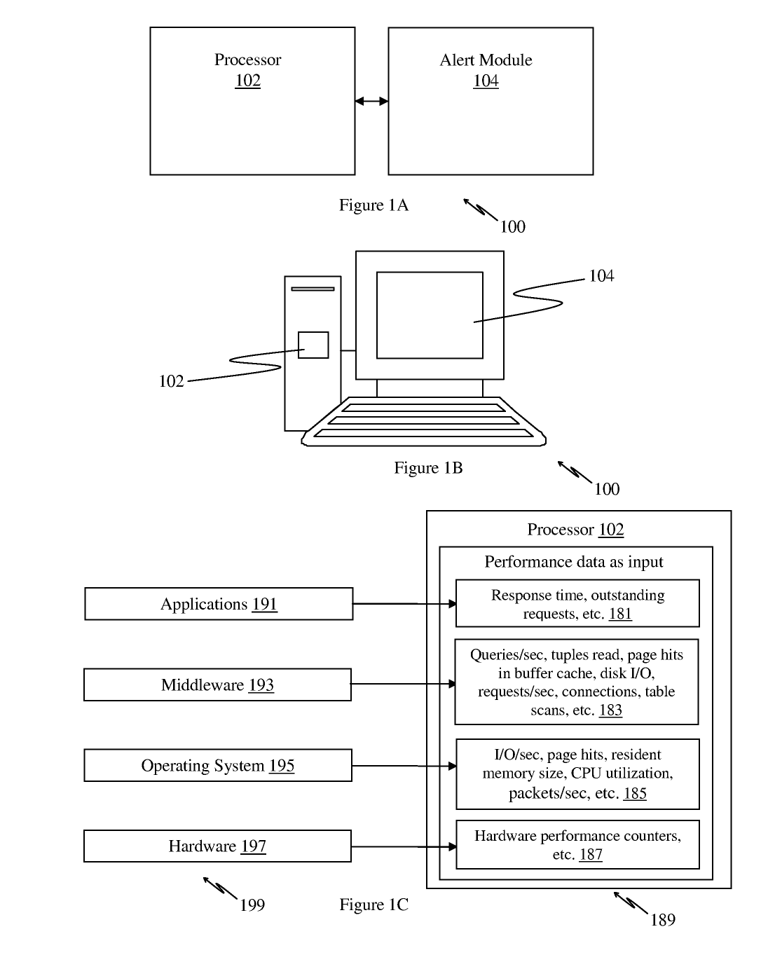

Referring to FIG. 1A, a system 100 comprises a processor 102 and an alert module 104 coupled to the processor 102. Referring to FIG. 1B, in at least one embodiment, the system 100 is a computer. As such, the processor 102 is a computer processor and the alert module 104 is a computer display. Many processors and alert modules are possible. For example, the processor 102 comprises a plurality of computer processors and the alert module 104 comprises a light-emitting diode coupled to an audio speaker in at least one embodiment.

The processor 102 preferably monitors performance data. FIG. 1C shows a stack 199 providing performance data 189 for trend determination and identification. The stack 199 comprises various layers of hardware and software from which the performance data 189 is measured. The performance data 189 is preferably collected by system performance monitors at the hardware layer 197, operating system layer 195, middleware layer 193, and applications layer 191. Each of these layers provides multiple categories of performance data. Hardware layer 197 provides hardware performance data 187 such as hardware performance counters, etc. Operating system layer 195 provides operating system performance data 185 such as I/O/sec, memory allocation, page faults, page hits, resident memory size, CPU utilization, packets/sec, etc. Middleware layer 193 provides middleware performance data 183 such as queries/sec, tuples read, page hits in buffer cache, disk I/O, table scans, requests/sec, connections, etc. Applications layer 191 provides application performance data such as response time, outstanding requests, previous transactions, etc. Many categories of performance data are possible. In at least one embodiment, the performance data is collected from a network. As such, hardware layer 197 provides hardware performance data 187 for the hardware of the entire network. Similarly, the other layers provide performance data for the entire network. In at least one embodiment, the performance data comprises application metrics and operating system metrics. However, monitoring any type of performance data is possible.

The processor 102 preferably constructs a model of SLO compliance based on the monitored performance data. Let S={SLO compliance, SLO violation} be the set of possible states for a given SLO. At any time t, the state of an SLO, Sₜ, may be in one of these two states. Let Mₜ denote a vector of values, [m₀, m₁, m₂, . . . , mₙ]ₜ, collected by the processor 102 using the performance indicators being monitored. The processor 102 preferably constructs a model F(M,k,Δ) that maps the input vector [Mₜ₋ₖ, Mₜ₋ₖ₊₁, . . . , Mₜ] to S_{t+Δ}, the state of the SLO at time t+A. In at least one embodiment, the thresholds k and A are parameters. In at least one other embodiment, the parameter k is infinite and the processor 102 uses all the available history of the performance indicator values to construct the model F(M,k,Δ). There are a variety of machine learning techniques that the processor 102 uses to construct the model F(M,k,Δ). For example, machine learning techniques used in processor 102 include, but are not limited to, naïve Bayes classifier, support vector machines, decision trees, Bayesian networks, or neural networks. For the details of these techniques, refer to T. Hastie, R. Tibrishani, and J. Friedman, The elements of statistical learning, Springer, 2001. In at least one embodiment, the processor 102 preferably constructs the model F(M,k,Δ) in a classifier C, approximating the function F(M,k,Δ), based on a given training set containing the past observations of the performance indicators and the observed state of the SLO metrics.

In at least one embodiment, the processor 102 combines values of the performance indicators with the directionality of these values over time. Let Dₜ=[{+,=,−}₁, {+,=,−}₂, {+,=,−}₃, . . . , {+,=,−}ₙ]ₜ be a directionality vector, indicating the directional difference between Mₜ and Mₜ₋₁. Each element eⱼ in Dₜ indicates whether or not the corresponding metric j in Mₜ has increased ({+} value), decreased ({−} value), or stayed the same ({=} value). In at least one embodiment, the processor 102 constructs a model F(M,k,Δ) that maps the input vector [Mₜ, Dₜ₋ₖ, Dₜ₋ₖ₊₁, . . . , Dₜ] to S_{t+Δ}, the state of the SLO at time t+Δ.

While monitoring each piece of performance data is possible, the cost of monitoring would be prohibitive as the amount of performance data increases. As such, the processor 102 determines a subset of the performance data correlated with a measure of underperformance. In at least one embodiment, the measure of underperformance is based on a service level objective (“SLO”). A SLO is preferably a portion of a service level agreement (“SLA”) between a service provider and a customer. SLOs are agreed means of measuring the performance of the service provider and are helpful in managing expectations and avoiding disputes between the two parties. In at least one embodiment, the SLA is the entire agreement that specifies the SLOs, what service is to be provided and how the service is supported as well as times, locations, costs, performance, and responsibilities of the parties involved. The SLOs are specific measurable characteristics of the SLA, e.g., availability, throughput, frequency, response time, and quality. For example, an SLO between a website hosting service and the owner of a website may be that 99% of transactions submitted be completed in under one second, and the measure of underperformance tracks the SLO exactly. Expressed in words, the subset of performance data correlated with the measure of underperformance may be, for example, a tripling of website traffic in less than ten minutes.

In at least one embodiment, processor 102 selects the subsets of the performance indicators using a feature selection technique. The processor 102 selects the M−, a subset of M, such that the difference between their corresponding models F*(M*) and F(M) is minimal, with respect to the training set. The processor 102 preferably uses a greedy algorithm that eliminates a single metric m, at each step, such that |F(M−m)−F(M)| is minimal.

In at least one embodiment, the subset corresponds to one SLO. However, in at least one other embodiment, the SLO is composed of one or more performance indicators that are combined to produce an SLO achievement value. As such, an SLO may depend on multiple components, each of which has a performance indicator measurement. The weights applied to the performance indicator measurements when used to calculate the SLO achievement value depend on the nature of the service and which components are given priority by the service provider and the customer. Preferably, in such an embodiment, each of the multiple components corresponds to its own subset of performance data. In this way, the measure of underperformance is a combination of sub-measures of underperformance. In at least one embodiment, the correlation value between the subset and the measure of underperformance must be above a programmable threshold. As such, the selection of elements of performance data to include in the subset is not over-inclusive or under-inclusive.

If the subset is appropriately correlated with the measure of underperformance, the subset may be monitored to anticipate the measure. If the measure corresponds with an SLO violation, then a breach of the SLA agreement can be anticipated.

The processor 102 determines a trend of the subset of performance data, the trend also correlated with the measure of underperformance. Preferably, the processor 102 determines a trend correlated with an SLO violation itself. Determining a trend of the subset of performance data comprises determining that one element of the subset is behaving in a certain fashion, another element is behaving in a certain fashion, etc., where each behavior could be independent of each other behavior and each behavior need not occur simultaneously. The behaviors comprise a linear, exponential, arithmetic, geometric, etc., increase, decrease, oscillation, random movement, etc. The behaviors also include directionality. For example, the two behaviors {n₁=1, n₂=2, n₃=3} and {n₁=3, n₂=2, n₃=1}, where nₓ is the xth value of the element, are different behaviors even though each behavior contains the same values. The former behavior is a tripling in website traffic while the latter behavior is a reduction of website traffic by a third. In at least one embodiment, the behaviors can also be expressed as thresholds. For example, {1<n₁<2, 2<n₂<3, 3<n₃<4}. Specifically, the first value for the element is between 1 and 2, the second value is between 2 and 3, etc. As an example, a trend can be determined by determining that one element is increasing and another element is decreasing simultaneously over a particular period of time. Note that the behaviors of the elements need not always occur simultaneously. A number of adjustable parameters can be used to increase the correlation between a trend and a measure of underperformance, which allows for a more accurate prediction of the measure of underperformance. Such parameters comprise any or all of: the number of elements of performance data used for the subset, the number of samples collected for each element, the rate of recording of each element, the rate of change of an element, the rate of change of the entire trend, and correlations between different elements of the performance data themselves, e.g., if change in one element causes change in another element. Many adjustable parameters and combinations of parameters are possible. In at least one embodiment, the trend is a combination of sub-trends of the subset. For example, the processor determines different subsets of performance data that, when each subset is behaving in its own particular way, will result in a SLO violation, but when less than all subsets exhibit their behavior, will not result in a SLO violation.

In at least one embodiment, the processor 102 ceases to monitor the performance data except for the subset after determining the trend. Because monitoring itself is an added overhead that uses system resources, it is advantageous to keep the amount of system resources dedicated to monitoring at a minimum. As such, ceasing monitoring performance of performance data that has little or no correlation to the measure of underperformance is preferable. By monitoring the subset, the processor 102 is still able to identify an occurrence of the trend. After such identification, in at least one embodiment, the processor 102 monitors a second subset of the performance data. Preferably, the second subset comprises at least one element not in the subset. System administrators prefer to study various data sources to determine the root cause of SLO violations after the fact, and this dynamic control of the collection of diagnostics information (when and what kinds of more detailed monitoring and instrumentation to be turned on as the second subset) assists system administrators in the event that a SLO violation occurs. However, it is an inefficient use of resources to collect the same level of diagnostic information during normal operation. If a violation does occur, the processor 102 preferably refines the subset of performance data automatically. Many methods of refinement are possible.

Machine learning techniques determine and refine the trends that establish correlation between performance data and measures of underperformance. Because the machine learning techniques create succinct representations of correlations from a diverse set of data, the techniques are ideal for determining which performance metrics lead to underperformance and which performance metrics can be safely ignored. As such, the system 100 is self-refining. Specifically, instances of SLO violations provide positive examples for the training of the machine learning models while normal operating conditions, without SLO violations, provide the negative examples for training. As such, the subset of performance data correlated with the underperformance can be adjusted automatically, and if a highly correlated subset suddenly or gradually becomes uncorrelated for any reason, the subset can be adjusted to maintain a high correlation. In this way, a steady supply of positive and negative examples allow for self-refining. Manual refining is also possible.

The alert module 104 preferably outputs an alert based on the identification of a trend. In at least one embodiment, the processor 102 sends a signal to the alert module 104 to output the alert. In at least one embodiment, the alert is a combination of alerts comprising a visual alert, an audio alert, an email alert, etc. Many alerting methods are possible. Preferably, the measure of underperformance is a future measure of underperformance and the alert is output prior to occurrence of the future measure of underperformance. In at least one embodiment, the future measure of underperformance is based on an SLO.

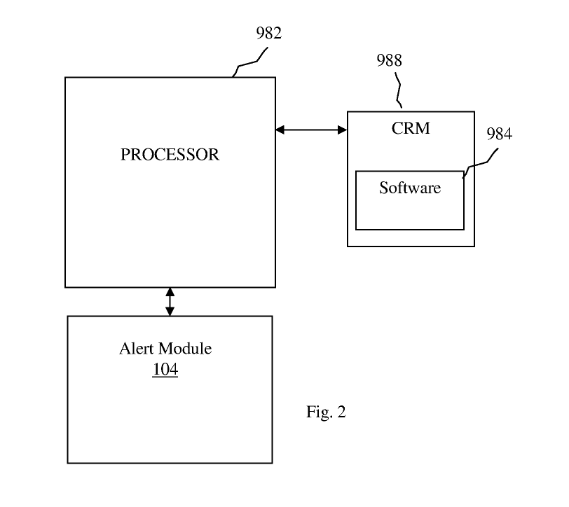

Referring to FIG. 2, in various embodiments, a computer-readable medium 988 comprises volatile memory (e.g., random access memory, etc.), non-volatile storage (e.g., read only memory, Flash memory, hard disk drive, CD ROM, etc.), or combinations thereof. The computer-readable medium comprises software 984 (which includes firmware) executed by the processor 982. One or more of the actions described in this document are performed by the processor 982 during execution of the software. Preferably the computer-readable medium 988 stores a software program 984 that, when executed by the processor 982, causes the processor 982 to monitor performance data and determine a subset of the performance data, the subset correlated with a measure of underperformance. Preferably, the processor 982 determines a trend of the subset, the trend correlated with the measure. In at least one embodiment, the processor 982 is further caused to cease to monitor the performance data except for the subset after determining the trend. The processor 982 preferably identifies an occurrence of the trend. In at least one embodiment, the processor 982 is further caused to monitor a second subset of the performance data after identifying the occurrence of the trend, the second subset comprising at least one element not in the subset. The processor 982 preferably outputs an alert based on the identification. In at least one embodiment, the alert is a signal to an alert module 104.

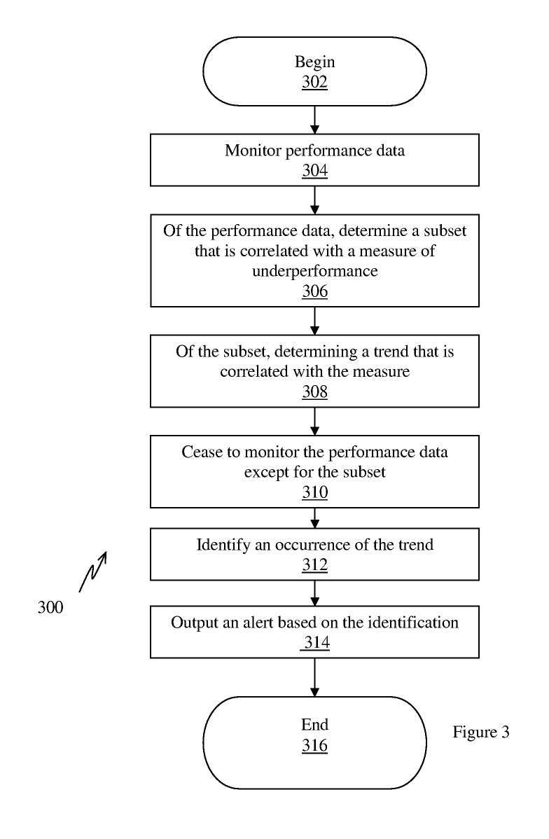

FIG. 3 illustrates a method 300, beginning at 302 and ending at 316, of trend determination and identification in accordance with at least some embodiments. One or more of the steps described in this document are performed during the method. At 304, performance data is monitored. At 306, a subset of the performance data is determined, the subset correlated with a measure of underperformance. At 308, a trend of the subset is determined, the trend correlated with the measure. In at least one embodiment, the performance data ceases to be monitored, except for the subset after determining the trend, at 310. At 312, an occurrence of the trend is identified. At 314, an alert is output based on the identification. In at least one embodiment, the alert is a signal to an alert module.

The above discussion is meant to be illustrative of the principles and various embodiments of the present invention. Numerous variations and modifications will become apparent to those having ordinary skill in the art once the above disclosure is fully appreciated. It is intended that the following claims be interpreted to embrace all such variations and modifications.

What is claimed is:

1. A system, comprising:
a processor; and
an alert module coupled to the processor;
wherein the processor
monitors performance data;
of the performance data, determines a subset that is correlated with a measure of underperformance;
of the subset, determines a trend that is correlated with the measure; and
identifies an occurrence of the trend; and
wherein the alert module outputs an alert based on the identification.

2. The system of claim 1, wherein the processor ceases to monitor the performance data except for the subset after determining the trend.

3. The system of claim 2, wherein the processor monitors a second subset of the performance data after identifying the occurrence of the trend, the second subset comprising at least one element not in the subset.

4. The system of claim 1, wherein the measure is a combination of sub-measures of performance.

5. The system of claim 1, wherein the trend is a combination of sub-trends of the subset.

6. The system of claim 1, wherein the measure of underperformance is based on a service level objective.

7. The system of claim 1, wherein the performance data comprises application metrics, operating system metrics, middleware metrics, and hardware metrics.

8. The system of claim 7, wherein the middleware metrics are selected from the group consisting of queries per second, tuples read, page hits in buffer cache, disk input/output, page hits, requests per second, connections, and table scans.

9. The system of claim 7, wherein the operating system metrics are selected from the group consisting of input/output operations per second, memory allocation, page faults, page hits, resident memory size, central processing unit utilization, and packets transferred per second.

10. The system of claim 7, wherein the application metrics are selected from the group consisting of previous transactions, response time, and outstanding requests.

11. A computer-readable medium storing a software program that, when executed by a processor, causes the processor to:
monitor performance data;
of the performance data, determines a subset that is correlated with a measure of underperformance;
of the subset, determines a trend that is correlated with the measure;
identify an occurrence of the trend; and
output an alert based on the identification.

12. The computer-readable medium of claim 11, further causing the processor to cease to monitor the performance data except for the subset after determining the trend.

13. The computer-readable medium of claim 11, further causing the processor to monitor a second subset of the performance data after identifying the occurrence of the trend, the second subset comprising at least one element not in the subset.

14. A method, comprising:
monitoring performance data;
of the performance data, determining a subset that is correlated with a measure of underperformance;
of the subset, determining a trend that is correlated with the measure;
identifying an occurrence of the trend; and
outputting an alert based on the identification.

15. The method of claim 14, further comprising ceasing to monitor the performance data except for the subset after determining the trend.

16. The system of claim 1, wherein the measure of underperformance is a future measure of underperformance.

17. The system of claim 16, wherein the future measure of underperformance is based on a service level objective.
